(19) United States
(12) Patent Application Publication
(10) Pub. No.: US 2004/0001985 A1
(43) Pub. Date: Jan. 1, 2004

(54) Fuel cell cooling system

(75) Inventor: Julio Alva, Brampton (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Hydrogenics Corporation

(21) Appl. No.: 10/184,104

(22) Filed: Jun. 28, 2002

(51) Int. Cl. H01M 8/04

(52) U.S. Cl. 429/26; 429/25; 429/24; 429/13

(57) ABSTRACT

A fuel cell cooling system and a method of operating the fuel cell cooling system. The fuel cell cooling system has a first coolant circulation loop for selectably supplying coolant to a fuel cell and a second coolant circulation loop for selectably supplying coolant to the fuel cell. The method comprises: (a) selectably connecting one of the first coolant circulation loop and the second coolant circulation loop to a coolant inlet and a coolant outlet of the fuel cell for fluid communication therewith; (b) selectably disconnecting the other of the first coolant circulation loop and the second coolant circulation loop from the coolant inlet and the coolant outlet of the fuel cell to impede fluid communication therewith; (c) when the first circulation loop is connected with the coolant inlet and the coolant outlet of the fuel cell for fluid communication therewith, providing a positive pressure to coolant in the first coolant circulation loop upstream from the coolant inlet of the fuel cell; and (d) when the second circulation loop is connected with the coolant inlet and the coolant outlet of the fuel cell for fluid communication therewith, providing a negative pressure to coolant in the second coolant circulation loop downstream from the coolant outlet of the fuel cell.

### FIELD OF THE INVENTION

The present invention relates generally to a fuel cell cooling system. More particularly, the present invention relates to a fuel cell cooling system in which the fuel cell is capable to operate under either positive or negative pressure of coolant.

### BACKGROUND OF THE INVENTION

Fuel cells have been proposed as a clean, efficient and environmentally friendly source of power which can be utilized for various applications. A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode, i.e. the anode, where it reacts electrochemically in the presence of the electrolyte to produce electrons and cations. The electrons are conducted from the anode to a second electrode, i.e. the cathode, through an electrical circuit connected between the electrodes. Cations pass through the electrolyte to the cathode. Simultaneously, an oxidant, such as oxygen gas or air is introduced to the cathode where the oxidant reacts electrochemically in presence of the electrolyte and catalyst, producing anions and consuming the electrons circulated through the electrical circuit; the cations are consumed at the second electrode. The anions formed at the second electrode or cathode react with the cations to form a reaction product. The anode may alternatively be referred to as a fuel or oxidizing electrode, and the cathode may alternatively be referred to as an oxidant or reducing electrode. The half-cell reactions at the two electrodes are, respectively, as follows:

$${H}_{2} -> 2 {H}^{+} + 2 {e}^{-}$$

$$\frac{1}{2} {O}^{2} + 2 {H}^{+} + 2 {e}^{-} -> {H}_{2} O$$

The external electrical circuit withdraws electrical current and thus receives electrical energy as shown by the sum of the separate half-cell reactions written above. Water and heat are typical by-products of the reaction. Accordingly, the use of fuel cells in power generation offers potential environmental benefits compared with power generation from combustion of fossil fuels or by nuclear activity. Some examples of applications are distributed residential power generation and automotive power systems to reduce emission levels.

In practice, fuel cells are not operated as single units. Rather fuel cells are connected in series, stacked one on top of the other, or placed side-by-side, to form what is usually referred to as a fuel cell stack. The fuel, oxidant and coolant are supplied through respective delivery subsystems to the fuel cell stack. Also within the stack are current collectors, cell-to-cell seals and insulation, with required piping and instrumentation provided externally to the fuel cell stack.

As fuel cell reactions are exothermic, heat generated within the fuel cell stack has to be dissipated to ensure that the fuel cells operate within an optimal temperature range. One of the commonly used methods of cooling a fuel cell stack is providing coolant flow passages within the fuel cell stack having a coolant inlet and a coolant outlet, and running liquid coolant through the fuel cell stack. A coolant circulation loop is typically provided, which includes a circulation pump and a heat exchanger. The circulation pump supplies the coolant to the coolant inlet of the fuel cell stack and draws the coolant from the coolant outlet. The coolant absorbs heat generated in the fuel cell stack, as it flows through the fuel cell stack. Outside the fuel cell stack, the coolant is cooled by a heat exchanger to within a predetermined temperature range. Typical coolant includes deionized water, pure water, any non-conductive water, ethylene glycol, the mixture thereof, etc.

The heat exchanger in the coolant circulation loop can be a radiator. Alternatively, the heat exchanger can be an isolation heat exchanger in which two fluids exchange heat in a non-mixing manner. In this case, another coolant circulation loop is provided. Depending on the system configuration and fuel cell power capacity, a heater may be provided in the coolant circulation loop either downstream or upstream of the heat exchanger to heat the coolant, thereby maintaining the temperature of the coolant within a desired range.

The coolant in the coolant circulation loop is usually pumped into the fuel cell stack. Hence, the fuel cell stack is usually referred to as operating under positive pressure of coolant. Alternatively, the circulation pump may be placed downstream of the fuel cell stack and draws coolant from the fuel cell stack. In this case, the fuel cell stack is referred to as operating under negative pressure of coolant. Prior fuel cell cooling systems can only provide either positive or negative pressure to the fuel cell stack. However in some cases, such as in fuel cell testing systems, in order to test the ability of a fuel cell stack to operate under different cooling conditions, it may be desirable to provide a fuel cell cooling system that is capable of operating a fuel cell stack under both positive pressure and negative pressure and switching between the two operating conditions. Although reversing the direction of the circulation pump may provide the desired pressure conditions, this cannot always satisfy the operational requirements for particular system configurations. For example, some components in the fuel cell system, such as pressure or flow regulators or even the fuel cell stack itself, may not work with the reversed flow direction of coolant. As a result, significant changes to the fuel cell system must be made to test the system under both positive and negative pressure conditions.

There remains a need for a fuel cell cooling system that can provide the fuel cell with both negative and positive pressure conditions without changing the system configuration.

### SUMMARY OF THE INVENTION

An object of an aspect of the present invention is to provide an improved fuel cell cooling system.

In accordance with an aspect of the present invention, there is provided a fuel cell cooling system comprising: (a) a first coolant circulation loop for supplying a coolant to a fuel cell, (b) a second coolant circulation loop for supplying the coolant to the fuel cell, and (c) coolant directing means for selectively directing the coolant from one of the first and second coolant circulation loops into the fuel cell and for impeding coolant flow from the other of the first and second coolant circulation loops into the fuel cell. The first coolant circulation loop has a first circulation means for effecting a positive pressure in the coolant upstream of the fuel cell to circulate the coolant through the fuel cell. The second coolant circulation loop has a second circulation means for effecting a negative pressure in the coolant downstream of the fuel cell to circulate the coolant through the fuel cell

An object of a second aspect of the present invention is to provide an improved method of operating a fuel cell cooling system.

In accordance with a second aspect of the present invention, there is provided a method of operating a fuel cell cooling system. The fuel cell cooling system has a first coolant circulation loop for selectably supplying coolant to a fuel cell and a second coolant circulation loop for selectably supplying coolant to the fuel cell. The method comprises: (a) selectably connecting one of the first coolant circulation loop and the second coolant circulation loop to a coolant inlet and a coolant outlet of the fuel cell for fluid communication therewith; (b) selectably disconnecting the other of the first coolant circulation loop and the second coolant circulation loop from the coolant inlet and the coolant outlet of the fuel cell to impede fluid communication therewith; (c) when the first circulation loop is connected with the coolant inlet and the coolant outlet of the fuel cell for fluid communication therewith, providing a positive pressure to coolant in the first coolant circulation loop upstream from the coolant inlet of the fuel cell; and (d) when the second circulation loop is connected with the coolant inlet and the coolant outlet of the fuel cell for fluid communication therewith, providing a negative pressure to coolant in the second coolant circulation loop downstream from the coolant outlet of the fuel cell.

The present invention provides a fuel cell cooling system that is capable of cooling a fuel cell under both positive and negative pressures. The components in the cooling system of the present invention do not need to be reconfigured to work in different pressure conditions. This is particularly desirable in fuel cell testing systems. The present invention has many advantages over the prior art when employed in fuel cell cooling systems having low flow rates. Increasing the turbulence of the coolant by mixing coolant in the first and second coolant circulation loops increases heat exchange efficiency in the coolant circulation loop. This in turn renders better control of the temperature of the coolant flowing through the fuel cell. Therefore, fuel cell is ensured to operate under optimum temperature and hence it is operating more efficiently.

Additionally, while the invention is described and claimed as providing a “cooling system”, more generally the system can provide both cooling and heating of the fuel cell 10. The coolant is thus more generally a heat transfer fluid. References to “cooling” and related terms should be construed accordingly.

### BRIEF DESCRIPTION OF THE DRAWINGS

For a better understanding of the present invention, and to show more clearly how it may be carried into effect, reference will now be made, by way of example, to the accompanying drawings, which show a preferred embodiment of the present invention and in which:

FIG. 1 illustrates a schematic flow diagram of a first embodiment of a fuel cell cooling system according to the present invention; and

FIG. 2 illustrates a schematic flow diagram of a second embodiment of the fuel cell cooling system according to the present invention.

### DETAILED DESCRIPTION OF THE INVENTION

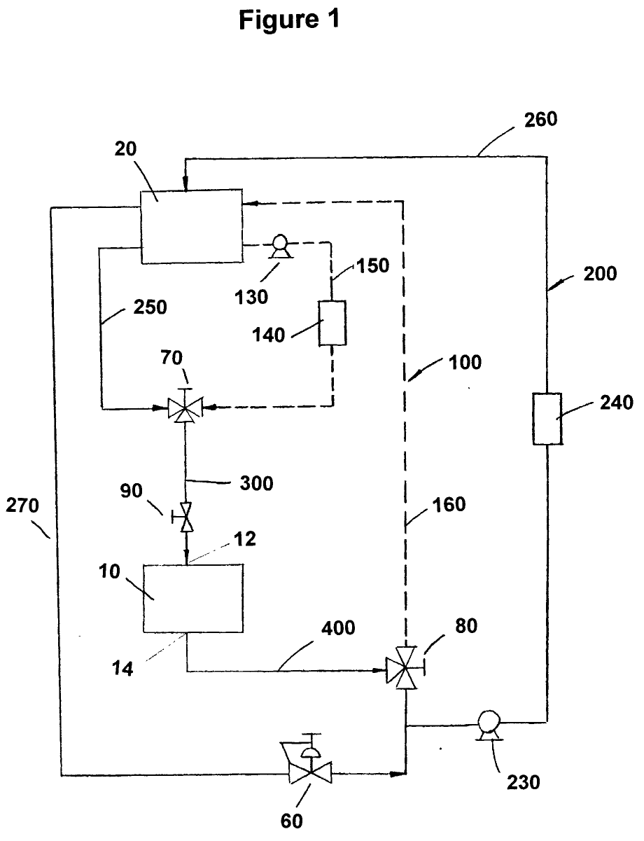

Referring to FIG. 1, this shows a schematic flow diagram of a first embodiment of a fuel cell cooling system 1 according to the present invention. The fuel cell cooling system 1 generally comprises a fuel cell 10, a coolant storage tank 20, a first coolant circulation loop 100 and a second coolant circulation loop 200. In known manner, the fuel cell 10 has a coolant inlet 12 and a coolant outlet 14 for coolant to flow through the fuel cell 10 and absorb heat generated in the fuel cell reaction. For clarity, lines unique of the first coolant circulation loop 100 are indicated with dash lines. It is to be understood that in the present invention, “fuel cell” is used to indicate a fuel cell stack comprising a plurality of fuel cells or just a single fuel cell. In addition, the present invention is applicable to any type of fuel cell.

As shown in FIG. 1, the first coolant circulation loop 100 comprises a first supply line 150, a first return line 160, a coolant inlet line 300 and a coolant outlet line 400. The first supply line 150 of the first coolant circulation loop 100 is in fluid communication with the coolant storage tank 20. A first coolant circulation pump 130 draws coolant from the coolant storage tank 20 and supplies it along the first supply line 150 to a first three-way valve 70 which, in one position, fluidly connects the first supply line 150 with the coolant inlet line 300. The coolant inlet line 300 is in turn in fluid communication with the coolant inlet 12 of the fuel cell 10. Then, the coolant continues to flow along the coolant inlet line 300 into the fuel cell 10. In this case, the fuel cell 10 is operating under positive pressure of coolant. Then in known manner, the coolant flows through the fuel cell 10, absorbs heat within the fuel cell 10 and leaves the fuel cell 10 via the coolant outlet 14. From the coolant outlet 14, the coolant flows along the coolant outlet line 400 which is in fluid communication with the coolant outlet, to a second three-way valve 80. In one position, the second three-way valve 80 fluidly connects the coolant outlet line 400 with first return line 160. Hence, the coolant flows from the second three-way valve 80 along the first return line 160 back to the coolant storage tank 20.

A first heat exchanger 140 is disposed in the first coolant circulation loop 100 to regulate the temperature of the coolant supplied to the fuel cell 10 so that a desired amount of heat generated within the fuel cell 10 is absorbed and hence the fuel cell 10 can operate under optimum temperature. In FIG. 1, the first heat exchanger 140 is disposed in the first supply line 150. However, it is to be understood that the first heat exchanger 140 may also be disposed in the first return line 160. It may be a radiator, or an isolation liquid-liquid heat exchanger. In the latter case, an additional cooling loop is required as is known in the art.

When the fuel cell cooling system 1 is operating under low coolant flow rate, for example, less than 1 liter per minute, heat loss in the conduits or pipes is relatively great. In order to prevent coolant temperature becoming too low when the coolant is circulated back to the fuel cell 10, a heater (not shown) may be desired. In addition, during initial start-up of the fuel cell 10, coolant is at a relatively low temperature. The heater helps to heat up the coolant during start-up to bring the coolant to desired temperature more rapidly. Such a heater may be disposed in the first supply line 150 or the first return line 160, either upstream or downstream of the first heat exchanger 140. Alternatively, the heater, for example an electric heater, may form an integral part of the coolant storage tank 20.

Still referring to FIG. 1, the second coolant circulation loop 200 comprises a second supply line 250, a second return line 260, a bypass line 270, the coolant inlet line 300 and the coolant outlet line 400. The second supply line 250 of the second coolant circulation loop 200 is in fluid communication with the coolant storage tank 20 and supplies coolant along the second supply line 150 to the first three-way valve 70. As mentioned above, in one position, the three-way valve 70 fluidly connects the first supply line 150 of the first coolant circulation loop 100 with the coolant inlet line 300. In the other position, the first three-way valve 70 fluidly connects the second line 250 of the second coolant circulation loop 200 with the coolant inlet line 300, and hence cuts off the fluid communication between the first supply line 150 and the coolant inlet line 300. Then, the coolant from the second supply line 250 flows along the coolant inlet line 300 into the fuel cell 10. In known manner, the coolant flows through the fuel cell 10, absorbs heat within the fuel cell 10 and leaves the fuel cell 10 via the coolant outlet 14. From the coolant outlet 14, the coolant flows along the coolant outlet line 400 which is in fluid communication with the coolant outlet 14, to the second three-way valve 80. As mentioned above, in one position, the second three-way valve 80 fluidly connects the coolant outlet line 400 with the first return line 160. In the other position, the second three-way valve 80 fluidly connects the coolant outlet line 400 with second return line 260 and hence cuts off the fluid communication between the coolant outlet line 400 and the first return line 160. Then, the coolant flows from the second three-way valve 80 along the second return line 260 back to the coolant storage tank 20. A second coolant circulation pump 230 is disposed in the second return line 260 of the second coolant circulation loop 200. It draws coolant from the fuel cell 10 and returns the coolant to the coolant storage tank 20. As the fuel cell 10 is located adjacent the inhalant side of the second coolant circulation pump 230, in this case the fuel cell 10 is operating under negative pressure of coolant.

As shown in FIG. 1, a first pressure regulating valve 90 is disposed in the coolant inlet line 300 upstream of and adjacent the coolant inlet of the fuel cell 10. The first pressure regulating valve 90 regulates the flow of coolant supplied to the fuel cell 10 in either positive or negative pressure operation. Particularly, in negative pressure operation, the pressure regulating valve 90 regulates the amount of coolant flow through the fuel cell 10. Hence, when the second coolant circulation pump 230 continuously draws coolant from the fuel cell 10, the first pressure regulating valve 90 regulates the negative pressure under which the fuel cell 10 operates, without changing the speed of the second coolant circulation pump 230.

A bypass line 270 is connected between the coolant storage tank 20 and a position in the second return line 260 upstream of the second coolant circulation pump 230, i.e. the inhalant side of the second coolant circulation pump 230. A second pressure regulating valve 60 is disposed in the bypass line 270 to regulate the amount of coolant supplied directly from the coolant storage tank 20 to the inhalant side of the second coolant circulation pump 230. The second pressure regulating valve 60 is normally closed. The second pressure regulating valve 60, by opening to different extents and hence supplying a portion of the coolant to the inhalant side of the second coolant circulation pump 230, reduces the negative pressure under which the fuel cell 10 operates to different extents. In known manner, the valve 60 can be a conventional pressure regulating valve, that effectively regulates the pressure drop across the fuel cell 10. This provides an additional mechanism of controlling negative pressure. It is to be understood that the bypass line 270 does not necessarily start from the coolant storage tank 20. It may start from any location upstream of the fuel cell 10, either in the first coolant circulation loop 100 or the second coolant circulation loop 200. Likewise, the bypass line 270 does not necessarily end at a position in the second return line 260 upstream of second coolant circulation pump 230. It may end at a position in the coolant outlet line 400.

Similar to the first heat exchanger 140 described above in the first coolant circulation loop 100, a second heat exchanger 240 is disposed in the second coolant circulation loop 200 to regulate the temperature of the coolant. In FIG. 1, the second heat exchanger 240 is located in the second return line 260 of the second coolant circulation loop 200. However, it may also be located in the second supply line 250. Again, the second heat exchanger may be a radiator or an isolation liquid-liquid heat exchanger. It is to be understood that the first or second heat exchanger 140, 240 may be disposed in the coolant inlet line 300 or coolant outlet line 400. In this case, only one heat exchanger is needed. Additional heat exchangers may be provided as desired. As mentioned above, a heater may be provided. Such a heater may be disposed in the second supply line 250 or the second return line 160, either upstream or downstream of the second heat exchanger 240. Alternatively, the heater, for example an electric heater, may form an integral part of the coolant storage tank 20. In this case, only one heater is needed.

It is to be understood that the coolant storage tank 20 may receive coolant from an external coolant source. It is also to be understood that the first and second coolant circulation pumps 130 and 230 used in the present invention may be constant speed pumps or variable speed pumps.

As can be appreciated from the description above, the fuel cell cooling system 1 of the present invention is capable of switching between two operation modes, a positive pressure mode and a negative pressure mode. In the positive pressure mode, coolant flows along the first coolant circulation loop 100, while in the negative pressure mode, coolant flows along the second coolant circulation loop 200. In the positive pressure mode, the first coolant circulation pump 130 operates and the second coolant circulation pump 230 is idle. In the negative pressure mode, the second coolant circulation pump 230 operates and the first coolant circulation pump 130 is idle. In other words, only one pump is working in either operation mode.

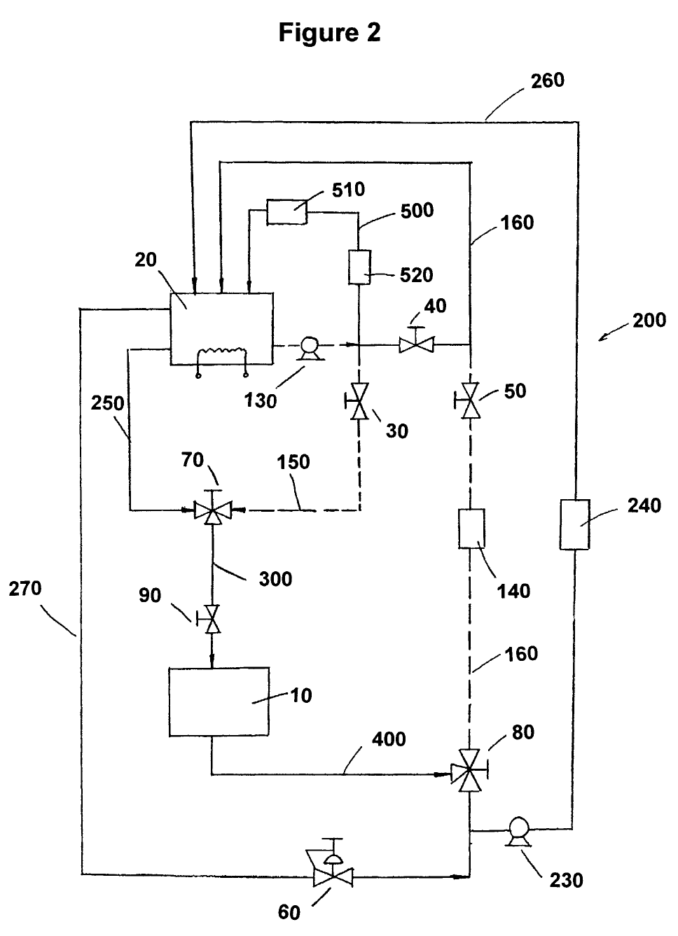

Now referring to FIG. 2, this shows a schematic flow diagram of a second embodiment of a fuel cell cooling system according to the present invention. The second embodiment is particularly suitable for use in low flow rate fuel cell cooling systems. For simplicity, the elements in this embodiment that are identical or similar to those in the first embodiment are indicated with same reference numbers and for brevity, the description of these elements is not repeated.

In this embodiment, a third coolant circulation loop 500 is provided. The first coolant circulation pump 130 draws coolant from the coolant storage tank 20 and supplies the coolant to the first supply line 150 and the third coolant circulation loop 500. A third heat exchanger 520 and a filter 510 are disposed in the third coolant circulation loop 500. The heat exchanger 520 regulates the temperature of the coolant in this loop 500 and the filter helps to purify the coolant. As in known in the art, as coolant flows along conduits and pipes, it picks up impurities particles and ions. To keep the coolant non-conductive so that the coolant does not short the fuel cell 10 when flowing therethrough, the filter 510 may be provided to filter out the impurities and ions. This is particularly useful when deionized water is used as the coolant. Depending on the type of coolant, the filter may be of different type or simply omitted.

As shown in FIG. 2, a first flow regulating valve 30 is provided in the first supply line 150, operating between open and closed positions. A second flow regulating valve 40 is connected between the first supply line 150 and the first return line 160. The second flow regulating valve 40 operates between open and closed positions and connects to a position upstream of the first flow regulating valve 30 in the first supply line 150. A third flow regulating valve 50 is provided in the first return line 160, operating between open and closed positions. The third flow regulating valve 50 is disposed upstream of the position at which the second flow regulating valve 40 connects to the first return line 160.

When the fuel cell cooling system 2 operates in positive pressure mode, the first and third flow regulating valves 30 and 50 are in open position and hence permit coolant to flow along the first coolant circulation loop 100. Meanwhile, the second flow regulating valve 40 is in closed position. The second coolant circulation pump 230 does not operate, as in the first embodiment. However, when the fuel cell cooling system 2 of the present invention operates under low flow rate of coolant (the flow rate in the first coolant circulation loop 100), e.g. less than 1 liter per minute, it may be desirable to operate the second coolant circulation pump 230. When the second coolant circulation pump 230 operates, the first and second three-way valves 70 and 80 are still in such a position that permits coolant to flow in the first coolant circulation loop 100. That is to say, the fluid communication between the second supply line 250 and the coolant inlet line 300, and the fluid communication between the coolant outlet line 400 and the second return line 260 are respectively cut off. Therefore, the second coolant circulation pump 230 draws coolant from the coolant storage tank 20 via the bypass line 270 and returns the coolant to the tank 20 via the second return line 260. This forms a complete circulation loop and coolant in this loop mixes with coolant in the first coolant circulation loop 100 in the coolant storage tank 20. The coolant storage tank 20 in this embodiment preferably has an integral heating means, as in low flow rate, the heating means is usually used to prevent the coolant temperature from deviating too far from the optimum range, i.e. being too cold. The mixing of the coolant in the tank 20 creates turbulence in the coolant, thereby increasing heat transfer efficiency. Preferably, the second coolant circulation pump 230 operates at a higher flow rate than that of the first coolant circulation pump 130 to give even higher heat transfer efficiency. Similar techniques for obtaining higher heat exchange efficiency in low flow rate cooling systems is disclosed in the assignee's co-pending U.S. patent application Ser. No. ______.

When the fuel cell cooling system 2 operates in negative pressure mode and low flow rate of coolant (the flow rate in the second coolant circulation loop 200), e.g. less than 1 liter per minute, the first and third flow regulating valves 30 and 50 are in closed position. The second coolant circulation pump 230 operates to draw coolant from the fuel cell 10 and the first and second three-way valves 70 and 80 are in such a position that permits coolant to flow in the second coolant circulation loop 200. That is to say, the fluid communication between the first supply line 150 and the coolant inlet line 300, and the fluid communication between the coolant outlet line 400 and the first return line 160 are respectively cut off. Meanwhile, the second flow regulating valve 40 is in open position, and the first coolant circulation pump 130 operates to draw coolant from the coolant storage tank 20 and supplies the coolant to flow through the second flow regulating valve 40 into the first return line 160. Then the coolant returns to the coolant storage tank 20 via the first return line 160. This forms a complete circulation loop and coolant in this loop mixes with coolant in the second coolant circulation loop 200 in the coolant storage tank 20. The mixing of the coolant in the tank 20 creates turbulence in the coolant and thereby increasing heat transfer efficiency. Preferably, in the negative pressure mode, the first coolant circulation pump 130 operates at a higher flow rate than that second coolant circulation pump 230 to give even higher heat transfer efficiency.

Optionally, since the first and second three-way valves 70 and 80 selectively cut off the coolant flow in the first coolant circulation loop 100, the first and third valves can be omitted. However, these two valves serve to minimize the amount of stagnant coolant in the first supply line 150 and part of the first return line 160. Hence, the first and third valves 30 and 50 are preferably disposed adjacent to the second valve 40. It is to be understood that in the second embodiment, the first heat exchanger 140 is disposed in the first return line 160. However, it may also be disposed in the first supply line 150. In addition, the first and second circulation pumps 130, 230 can be any type of pump commonly used. Preferably, at least the speed of one circulation pump is variable.

It is also to be understood that, in known manner, various sensors and/or transmitters can be provided for measuring parameters of the coolant, such as temperature, pressure, flow rate, etc. The measured parameters can be sent to a processor (not shown) which in turn controls the operation of the heating means, the first and second pumps 130, 230, and the heat exchangers 140, 240. For example, sensors or transmitters can be provided adjacent the coolant inlet and outlet of the fuel cell 10 to monitor the temperature of the coolant, and hence the amount of heat removed from the fuel cell 10. Similarly, sensors may also be provided adjacent the inlets and outlets of the coolant storage tank to monitor the temperature of the coolant, and hence the heating efficiency. The measured data is then sent to the processor for analysis. Then the process will control the operation of the components, such as increasing or decreasing the speed of the first or second pump, increasing or decreasing fan speed of radiators, if radiators are used as heat exchangers, increasing or decreasing heating, etc.

It should also be appreciated that the present invention is not limited to the embodiments disclosed herein. It can be anticipated that those having ordinary skills in the art can make various modifications to the embodiments disclosed herein without departing from the fair meaning or the proper scope of the accompanying claims. For example, the number and arrangement of components in the system might be different, different elements might be used to achieve the same specific function. However, these modifications should be considered to fall within the scope of the invention as defined in the following claims.

1. A fuel cell cooling system comprising:
a) a first coolant circulation loop for supplying a coolant to a fuel cell, the first coolant circulation loop having a first circulation means for effecting a positive pressure in the coolant upstream of the fuel cell to circulate the coolant through the fuel cell;
b) a second coolant circulation loop for supplying the coolant to the fuel cell, the second coolant circulation loop having a second circulation means for effecting a negative pressure in the coolant downstream of the fuel cell to circulate the coolant through the fuel cell; and,
c) coolant directing means for selectively directing the coolant from one of the first and second coolant circulation loops into the fuel cell and for impeding coolant flow from the other of the first and second coolant circulation loops into the fuel cell.

2. A fuel cell cooling system as claimed in claim 1, further comprising a coolant storage means, and wherein the first coolant circulation loop comprises a first supply line for supplying coolant from the coolant storage means to the fuel cell and a first return line for returning the coolant flowing through the fuel cell back to the coolant storage means, and wherein the second coolant circulation loop comprises a second supply line for supplying coolant from the coolant storage means to the fuel cell and a second return line for returning the coolant flowing through the fuel cell back to the coolant storage means.

3. A fuel cell cooling system as claimed in claim 2, wherein the first coolant circulation means is disposed in the first supply line to supply coolant to the fuel cell and the second coolant circulation means is disposed in the second return line to draw coolant from the fuel cell.

4. A fuel cell cooling system as claimed in claim 3, wherein the fuel cell has a coolant inlet for receiving coolant and a coolant outlet for discharging coolant.

5. A fuel cell cooling system as claimed in claim 4, wherein the coolant directing means comprises
a first joint means for selectively providing fluid communication between the coolant inlet and one of the first supply line and the second supply line, and impeding fluid communication between the coolant inlet and the other of the first supply line and the second supply line; and
a second joint means for selectively providing fluid communication between the coolant outlet and one of the first return line and the second return line, and impeding fluid communication between the coolant outlet and the other of the first return line and the second return line.

6. A fuel cell cooling system as claimed in claim 5, further comprising a first pressure regulating means upstream of the fuel cell.

7. A fuel cell cooling system as claimed in claim 6, further comprising a first bypass line for selectively directing a portion of coolant from upstream of the fuel cell to an inhalant side of the second coolant circulation means.

8. A fuel cell cooling system as claimed in claim 7, wherein a second pressure regulating means is provided in the first bypass line.

9. A fuel cell cooling system as claimed in claim 8, further comprising a second bypass line for selectively providing fluid communication between the first supply line and the first return line.

10. A fuel cell cooling system as claimed in claim 9, further comprising a first valve in the first supply line, a second valve in the second bypass line and a third valve in the first return line.

11. A fuel cell cooling system as claimed in claim 10, wherein the first and third valves are disposed adjacent to the second valve.

12. A fuel cell cooling system as claimed in claim 9, further comprising a heat exchanger means for cooling the coolant in at least one of the first and second coolant circulation loops.

13. A fuel cell cooling system as claimed in claim 12, further comprising a heating means for heating the coolant in at lest one of the first and second coolant circulation loops.

14. A fuel cell cooling system as claimed in claim 13, wherein the heating means comprises a heater in the coolant storage means.

15. A fuel cell cooling system as claimed in claim 14, further comprising a third coolant circulation loop connected to the coolant storage means, said third coolant circulation loop comprising a filter for purifying the coolant.

16. A fuel cell cooling system as claimed in claim 15, wherein the filter is an ion filter for deionizing the coolant.

17. A fuel cell cooling system as claimed in claim 16, wherein at least one of the first and second coolant circulation means is a pump having variable speed.

18. A fuel cell cooling system as claimed in claim 17, further comprising a plurality of temperature sensors for detecting the temperature of the coolant supplied to and exiting from the fuel cell and the temperature of the coolant in the coolant storage means.

19. A fuel cell cooling system as claimed in claim 18, further comprising a controller for controlling the heater, the heat exchanger means, the pressure regulating means and the coolant circulation means in response to the temperatures detected by the plurality of temperature sensors.

20. A method of operating a fuel cell cooling system to supply coolant to a fuel cell, the fuel cell cooling system having a first coolant circulation loop for selectably supplying coolant to a fuel cell and a second coolant circulation loop for selectably supplying coolant to the fuel cell, the method comprising:
a) selectably connecting one of the first coolant circulation loop and the second coolant circulation loop to a coolant inlet and a coolant outlet of the fuel cell for fluid communication therewith;
b) selectably disconnecting the other of the first coolant circulation loop and the second coolant circulation loop from the coolant inlet and the coolant outlet of the fuel cell to impede fluid communication therewith;
c) when the first circulation loop is connected with the coolant inlet and the coolant outlet of the fuel cell for fluid communication therewith, providing a positive pressure to coolant in the first coolant circulation loop upstream from the coolant inlet of the fuel cell; and
d) when the second circulation loop is connected with the coolant inlet and the coolant outlet of the fuel cell for fluid communication therewith, providing a negative pressure to coolant in the second coolant circulation loop downstream from the coolant outlet of the fuel cell.

21. A method of operating a fuel cell cooling system as claimed in claim 20, wherein step c) comprises pumping the coolant to the coolant inlet of the fuel cell using a first pump and step d) comprises drawing the coolant from the coolant outlet of the fuel cell using a second pump.

22. A method of operating a fuel cell cooling system as claimed in claim 21, wherein step c) further includes circulating the coolant between a coolant storage means and the fuel cell and step d) further includes circulating the coolant between the coolant storage means and the fuel cell.

23. A method of operating a fuel cell cooling system as claimed in claim 22, wherein step d) further includes regulating the flow of the coolant upstream of the fuel cell.

24. A method of operating a fuel cell cooling system as claimed in claim 23, wherein step d) further includes selectively directing a portion of coolant from upstream of the fuel cell to the inhalant side of the second pump.

25. A method of operating a fuel cell cooling system as claimed in claim 22, wherein step d) further includes (i) using the first pump to circulate a first bypass portion of the coolant bypassing the fuel cell from the coolant storage means and (ii) mixing the first bypass portion of the coolant with the coolant of the second coolant circulation loop in the coolant storage means.

26. A method of operating a fuel cell cooling system as claimed in claim 25, wherein step (c) further includes (i) using the second pump to circulate a second bypass portion of the coolant bypassing the fuel cell from the coolant storage means and (ii) mixing the second bypass portion of the coolant with the coolant of the first coolant circulation loop in the coolant storage means.

27. A method of operating a fuel cell cooling system as claimed in claim 26, further comprising heating the mixture of the coolant in the storage means.

28. A method of operating a fuel cell cooling system as claimed in claim 27, wherein step d) comprises operating the first pump at a higher flow rate that the second pump and step c) comprises operating the second pump at a higher flow rate that the first pump.

29. A method of operating a fuel cell cooling system as claimed in claim 28, further comprising circulating a portion of the coolant from the coolant storage means along a third coolant circulation loop and purifying the coolant in the third coolant circulation loop.

30. A method of operating a fuel cell cooling system as claimed in claim 29, further comprising cooling the coolant after the coolant flows through the fuel cell.

31. A method of operating a fuel cell cooling system as claimed in claim 30, further comprising detecting the temperature of the coolant supplied to and exiting from the fuel cell and the temperature of the coolant in the coolant storage means.

32. A method of operating a fuel cell cooling system as claimed in claim 31, further comprising controlling the heating, coolant and the flow rate of the coolant in response to the detected temperatures by the temperature sensors.
